(19) United States
(12) Patent Application Publication
(10) Pub. No.: US 2017/0346953 A1
(43) Pub. Date: Nov. 30, 2017

(54) CONNECTED FARMING SYSTEM WITH GRAIN BIN CONDITION REPORTING AND CONTROL

(71) Applicant: Shafagh Abassi, New York, NY (US)

(72) Inventor: Shafagh Abassi, New York, NY (US)

(73) Assignee: AgPlexus, LLC, New York, NY (US)

(21) Appl. No.: 15/164,931

(22) Filed: May 26, 2016

(51) Int. Cl. H04M 11/00; G01K 1/14; H04B 3/36; H04W 84/18; H04W 88/02; H04W 88/16; H04W 84/12

(52) U.S. Cl. CPC H04M 11/007; H04B 3/36; G01K 1/14; H04W 84/12; H04W 88/02; H04W 88/16; H04W 84/18

(57) ABSTRACT

A system and methodology associated with a connected farming system utilizing a novel system architecture which includes grain bin sensors that detect grain temperatures and/or moisture levels at multiple locations within a grain bin and wherein sensory data is communicated to a reader device so as to permit the reader device to detect one or more hot spots, heating conditions within the grain housed in the grain bin. The indicia of these hot spots, and/or heating conditions and/or raw sensory data are wirelessly communicated to a gateway device which may further communicate the presence or absence of these hot spots and/or heating conditions and/or raw sensory data to one or more user devices via a network connection and/or the cloud. The system and methodology also permits the detection and reporting of a possible grain theft occurrence within one or more grain bins.

### FIELD OF THE DISCLOSURE

Embodiments of the present invention relate generally to systems and methods for remotely detecting and reporting on conditions associated with farming activities and more particularly to a wireless connected farming system with sensor based condition analysis for grain bins and remotely controlling farming equipment such as grain bin aeration fans.

### BACKGROUND

Not unlike most industries, farming methodologies have been improved and made more efficient through various technological developments in recent years. There are some unique issues involved in improving farming operations and related efficiencies. One area in which improvements have been made available to farmers is with respect to the remote monitoring of crop and grain bin conditions as well as soil conditions, micro-climates (weather stations) as well as the remote automation of various tasks.

There exist systems through which various parameters associated with grain bins can be monitored remotely and through which reporting to farmers and/or other interested parties can be made. However, these systems suffer from a number of drawbacks. One such drawback is the relatively large cost of deploying these kinds of systems across a reasonably sized farm. Another drawback is the difficulty or impossibility of being able to integrate all of the required sensors/nodes into a single system.

An average farm may have 40 to 100 or more grain bins spread across the land area of the farm at various locations. In existing deployments with current systems, short range radio communication protocols and RF components are typically used to wirelessly link sensors and/or sensor readers with the gateway which provides network connectivity. These networks typically have a low sensor/node capacity (typically limited to approximately 20-30 sensors/nodes per network).

Because of this limited range and because grain bins are not usually close enough in geographical proximity to share a gateway, it is typically necessary to architect systems with a gateway located at each grain bin or, at best, a gateway at each group of geographically adjacent bins. These gateways can be relatively expensive and there may be a connectivity fee associated with each of these gateways. These expenses alone may make deployment across multiple grain bins impracticable for many farmers.

In addition, in many remote monitoring applications currently in use, once captured data is acquired by a sensor or sensor/reader combination, that data is uploaded to a remote server via an external network such as the internet or some other private or public network. If and when the link between the local network and the server where the data is stored is lost, the previously captured data becomes unavailable and also the data captured during the time in which the link was broken can be lost. This can cause a number of problems depending upon the specific application. In temperature and humidity monitoring applications, when historical data is unavailable, it becomes very difficult to provide reporting and decision support based only on current data without access to historical data points for comparison purposes. Also, in the event of a loss in connectivity between some or all of the gateways and the internet, the farmer may be unable to access sensory data notwithstanding that he/she has connectivity with one or more of the gateways.

One particular application which lends itself to remote monitoring in a farming environment is the detection of “hot spots” within grain being held in a grain bin. While existing systems provide this capability, they do suffer from drawbacks such as short range (less than 50 meters from the gateway) as well as being subject to unavailability when a data link is broken. Another application which is of interest to farmers is the remote monitoring of the amount of grain in a bin over the course of time. A specific extension of this is the ability to monitor and detect a rapid reduction in grain bin level which may imply potential theft of grain and/or other problems which need to be addressed. While there exist systems and methodologies for grain bin level monitoring, these systems and methodologies suffer from various drawbacks which are addressed by the teachings of the present invention.

### SUMMARY

It is to be understood that both the following summary and the detailed description are exemplary and explanatory and are intended to provide further explanation of the present invention as claimed. Neither the summary nor the description that follows is intended to define or limit the scope of the present invention to the particular features mentioned in the summary or in the description. Rather, the scope of the present invention is defined by the appended claims.

In certain embodiments, the disclosed embodiments may include one or more of the features described herein.

An aspect of the present invention provides a method of operating a parameter-sensing device connected to a reader device which is in turn wirelessly connected to a gateway device, the method comprising: employing the parameter sensing device to sample values of parameters either one time or periodically over some time period, receiving those values at a reader device, wirelessly transmitting those values from the reader device to a gateway device, and storing all or a portion of the values at either or both of the reader device and/or the gateway device. In some embodiments, the gateway then sends all or a portion of the parameters/sensory data to the cloud via a network such as a cellular or Wi-Fi network.

Another aspect of the invention provides a method of operating a parameter-sensing device connected to a reader device which is in turn wirelessly connected to a gateway device, the method comprising: employing the parameter sensing device to sample values of parameters either one time or periodically over some time period, receiving those values at a reader device, wirelessly transmitting those values from the reader device to a gateway device, storing all or a portion of the values at either or both of the reader device and/or the gateway device. In some embodiments, the gateway then sends all or a portion of the parameters/sensory data to the cloud via a network such as a cellular or Wi-Fi network. The values and/or decision support capabilities are then available, via the cloud or the gateway device, to a user device such as a computer, smart phone, tablet or dedicated display device.

A further aspect of the invention provides a system incorporating multiple parameter-sensing devices, at least one reader device, at least one gateway device and at least one user device wherein the parameter-sensing devices communicate parameter values to a reader device which in turn wirelessly communicates these parameter values to a gateway device, and wherein the parameter values are made available to users via the user devices based upon a network connection between the gateway device and the user device.

A still further aspect of the invention provides a plurality of grain bin sensors, such grain bin sensors being connected to a reader device and wherein a plurality of reader devices communicate wirelessly to a gateway device which is accessible by at least one user device via a network connection.

A yet further aspect of the invention provides a plurality of grain bin sensors, such grain bin sensors being connected to a reader device and wherein a plurality of reader devices communicate wirelessly to a gateway device which is accessible by at least one user device via the cloud or other public or private network.

Another aspect of the invention includes grain bin sensors which detect grain temperatures at multiple locations within a grain bin and wherein these temperatures are communicated to a reader device so as to permit the reader device to detect one or more “hot spots” within the grain housed in the grain bin. According to this embodiment, the indicia of these hot spots are wirelessly communicated to a gateway device which may further communicate the presence or absence of these “hot spots” to one or more user devices via a network connection.

A still further aspect of the invention includes grain bin sensors which detect grain temperatures at multiple locations within a grain bin and wherein these temperatures are communicated to a reader device so as to permit the reader device to detect one or more “hot spots” within the grain housed in the grain bin. According to this embodiment, the indicia of these hot spots are wirelessly communicated to a gateway device which may further communicate the presence or absence of these “hot spots” to one or more user devices via the cloud or via a public or private network.

A further aspect of the invention includes grain bin sensors which detect grain temperatures at multiple locations within a grain bin and wherein these temperatures are communicated to a reader device so as to permit the reader device to determine the level of the grain housed in the grain bin. According to this embodiment, the indicia of this level is wirelessly communicated to a gateway device which may further communicate this level to one or more user devices via a network connection and/or to the cloud via a public or private network.

An even further aspect of the invention includes grain bin sensors which detect grain temperatures at multiple locations within a grain bin and wherein these temperatures are communicated to a reader device so as to permit the reader device to determine if there is a potential theft/rapid depletion of the grain housed in the grain bin. According to this embodiment, the indicia of this potential theft/rapid depletion is wirelessly communicated to a gateway device which may further communicate this condition to one or more user devices via a network connection and/or to the cloud via a public or private network.

These and further and other objects and features of the present invention are apparent in the disclosure, which includes the above and ongoing written specification, with the drawings.

### BRIEF DESCRIPTION OF THE DRAWINGS

The accompanying drawings, which are incorporated herein and form a part of the specification, illustrate exemplary embodiments and, together with the description, further serve to enable a person skilled in the pertinent art to make and use these embodiments and others that will be apparent to those skilled in the art. Embodiments of the present invention will be more particularly described in conjunction with the following drawings wherein:

FIG. 1 is a block diagram of a connected farming network, according to an embodiment of the present invention;

FIG. 2 is a block diagram of a connected farming network, including a repeater component, according to another embodiment of the present invention;

FIG. 3 is a more detailed block diagram of the components present at the grain bin location, according to an embodiment of the present invention;

FIG. 4 is a graphical plot illustrating a heating condition within a grain bin as detected by the system of the present invention, according to an embodiment thereof;

FIG. 5 is a graphical plot illustrating a “hot spot” condition within a grain bin as detected by the system of the present invention, according to an embodiment thereof; and

FIG. 6 is a flowchart illustrating the methodology for detecting a possible grain theft/rapid grain depletion condition within a grain bin, according to an embodiment thereof.

### DETAILED DESCRIPTION

Embodiments of wireless parameter-sensing node in a network thereof will now be disclosed in terms of various exemplary embodiments. This specification discloses one or more embodiments that incorporate features of the present invention. The embodiment(s) described, and references in the specification to “one embodiment”, “an embodiment”, “an example embodiment”, etc., indicate that the embodiment(s) described may include a particular feature, structure, or characteristic. Such phrases are not necessarily referring to the same embodiment. The skilled artisan will appreciate that a particular feature, structure, or characteristic described in connection with one embodiment is not necessarily limited to that embodiment but typically has relevance and applicability to one or more other embodiments.

In the several figures, like reference numerals may be used for like elements having like functions even in different drawings. The embodiments described, and their detailed construction and elements, are merely provided to assist in a comprehensive understanding of the present invention. Thus, it is apparent that the present invention can be carried out in a variety of ways, and does not require any of the specific features described herein. Also, well-known functions or constructions are not described in detail since they would obscure the present invention with unnecessary detail.

The description is not to be taken in a limiting sense, but is made merely for the purpose of illustrating the general principles of the present invention, since the scope of the present invention is best defined by the appended claims.

It should also be noted that in some alternative implementations, the blocks in a flowchart, the communications in a sequence-diagram, the states in a state-diagram, etc., may occur out of the orders illustrated in the figures. That is, the illustrated orders of the blocks/communications/states are not intended to be limiting. Rather, the illustrated blocks/communications/states may be reordered into any suitable order, and some of the blocks/communications/states could occur simultaneously.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or” includes any and all combinations of one or more of the associated listed items. As used herein, the singular forms “a”, “an” and “the” are intended to include the plural forms as well, unless the context clearly indicates otherwise.

The word “exemplary” is used herein to mean “serving as an example, instance, or illustration.” Any embodiment described herein as “exemplary” is not necessarily to be construed as preferred or advantageous over other embodiments. Additionally, all embodiments described herein should be considered exemplary unless otherwise stated.

The word “network” is used herein to mean one or more conventional or proprietary networks using an appropriate network data transmission protocol. Examples of such networks include, PSTN, LAN, WAN, WiFi, WiMax, Internet, 35 World Wide Web, Ethernet, other wireless networks, and the like.

The phrase “wireless device” is used herein to mean one or more conventional or proprietary devices using radio frequency transmission techniques. Examples of such wireless devices include cellular telephones, desktop computers, laptop computers, handheld computers, electronic games, portable digital assistants, MP3 players, DVD players, or the like.

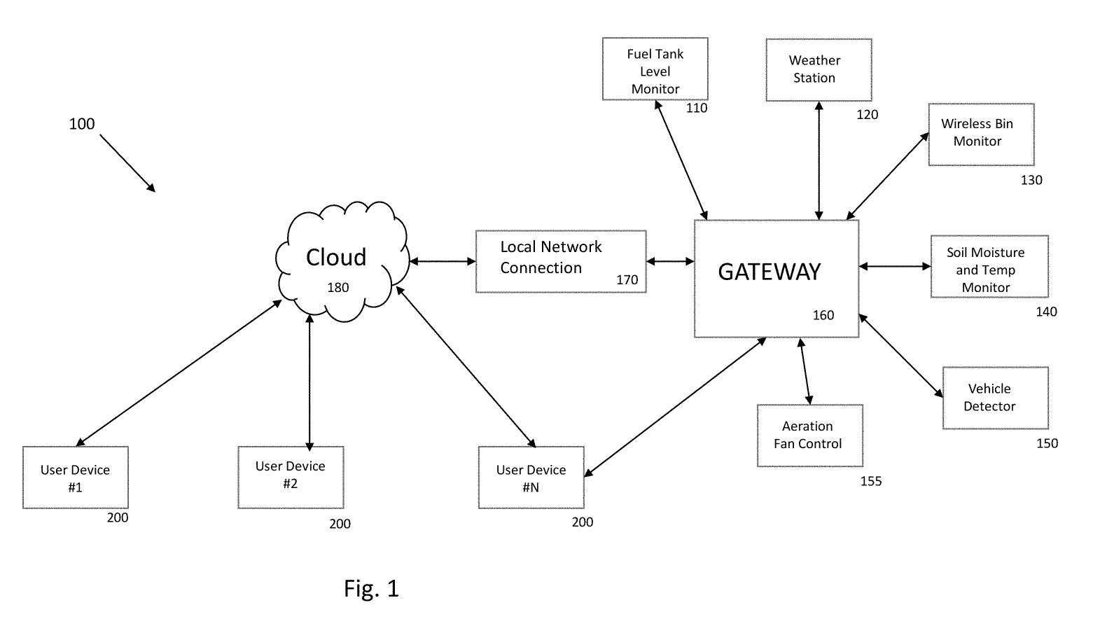

With reference now to FIG. 1 the various components of the connected farming network 100 of the present invention are described. Various sensor/reader pairs (110, 120, 130, 140, 150 and 155) communicate with gateway 160 as more fully described herein. Each of these sensor/reader pairs is provided to detect and report one or more specific parameters applicable to a farming environment. While exemplary sensor/reader pairs are described herein, the invention is not necessarily limited thereto and various other sensor/reader pairs may be employed in the connected farming network 100 of the present invention without departing from the scope or spirit thereof.

In a preferred embodiment of the present invention, fuel tank level monitor sensor/reader pair 110 is provided so as to detect the level in one or more fuel tanks located at various geographic locations within a farm or within a group of farms. The sensor/reader pairs include a parametric sensor device, in this case, a sensor which senses fuel or other liquid or gas levels via one or more known methodologies combined with a reader component which is configured to process the sensed data and communicate this data in raw form or in processed form to gateway 160.

As such, the reader component preferably includes a processor, local storage, RF capability enabling wireless communication to gateway 160 and software and/or firmware which is responsible for some or all of: (i) processing the received raw data into processed data, (ii) managing the storage and retrieval of data, and (iii) managing the timing and protocol for communication with gateway 160 as well as other functions. Communication between the sensor component and the reader component may be wired or wireless. In addition, various near field communication protocols such as Bluetooth, RFID and other similar technologies may be used to communicate data from the sensor to the reader device.

Data may be reported by the reader to gateway 160 in raw form essentially as received from the related sensor device. For example, in the case of fuel tank level monitor sensor pair 110, data reporting to gateway 160 may be a series of levels reported on a periodic basis over some time period or on an ongoing basis. For example, fuel tank level monitor 110 may report a fuel level (e.g. 1/10 full, ½ full, ¾ full etc.) to gateway 160 every fifteen minutes during daylight hours. Another possibility is to monitor the level constantly but only transmit to gateway 160 in the event of a change from the previous state. This embodiment is especially effective when power conservation is desired.

The above are merely examples and system 100 and each sensor/reader pair may be separately configured via user devices 200 (described in more detail below) in terms of reporting protocol, sensitivity and other factors. As will be recognized by one of skill in the art, there are various tradeoffs in selecting specific configurations such as the fact that more frequent reporting by the sensor/reader pair will result in more rapid battery depletion in the case where the sensor and/or reader components are battery powered.

Along those lines, it should be noted that in many farming deployments, the sensor/reader pairs will be remotely located, difficult to access and may also have significant limitations in terms of size (i.e. the sensors may need to be very small), and/or may be located in places where electrical power is not available. Thus, in a preferred embodiment of the present invention, both the sensors and the readers are battery powered—although this is not required. Alternative power sources are also possible such as through the use of energy harvesting components including small solar panels if access to sunlight or other light is available.

Returning now to FIG. 1, the other sensor/reader pairs shown in the Figure will now be briefly described as to purpose with the understanding that they are configured to operate as has been just described above with respect to fuel tank level monitor 110 provided that the nature of the specific sensor may deviate so that it can perform the desired sensing function. Weather station 120 may include one or more sensors for detecting various weather conditions at different locations within a single farm or at multiple different farms. Such conditions may include humidity, temperature, precipitation amounts as well as other conditions. Multiple weather stations 120 may be present on a single farm at various locations to measure different micro-climates.

Soil moisture and temperature monitor 140 may include sensors which are embedded in soil at various locations around a single farm or multiple farms. Temperatures and/or humidity at various locations and various depths may be sensed and reported according to the teachings contained herein. Vehicle detector 150 may detect the event of a vehicle or other movable farming machinery passing over a road or other location on one or more farms. This is typically triggered when such a vehicle passes one or more predefined locations within the farm based on the presence of one or more sensor/reader pairs being present at that location. In some embodiments, vehicle detector can determine and report the direction in which the vehicle and/or machinery is traveling.

Wireless Bin Monitor 130, for which additional detail is provided below, is comprised of a number of sensor/reader pairs designed to monitor a number of conditions within grain bins located at one or more locations on a farm or across multiple farms. As will be discussed in further detail below, these conditions include the level of grain within a bin, the temperature inside the bin, whether or not there are one or more “hot spots” within the bin and/or whether the grain inside the bin is heading and/or whether there is or has been a rapid depletion of the level of grain in a bin (which may indicate the possibility of theft and/or some other issue that requires attention). Various other parameters may be sensed through the inclusion of appropriate sensing capabilities. For example, wireless bin monitor (and/or other of the referenced components comprising system 100) may include a carbon dioxide sensing capability which can be used to report raw carbon dioxide readings and/or specific grain conditions based on specific carbon dioxide levels and/or changes thereto.

System 100 may also include aeration fan control 155 which may be selectively turned on and off based on control input. In addition, speed and/or fan direction by be controlled remotely via user devices 200. Control may be as manually selected by a user via user device 200 or under system control depending upon one or more detected parameters and/or system conditions. For example, one or more aeration fans located at one or more grain bins can be automatically turned on in the case of detection of a hot spot and/or a humidity level that exceeds a specified threshold.

With reference once again to FIG. 1, gateway 160 is preferably a machine to machine connectivity platform which provides long range and low power wireless communication capabilities including with the various sensor/reader pairs described above. In one embodiment, gateway 160 may comprise the Symphony Link and/or LoRa Enabled M2M Gateway model LL-BST-8 available from Link Labs in Annapolis, Md. This gateway provides various advantages derived from the LoRa protocol and Symphony Link network (http:www.link-labs.com/symphony) including the ability to support an extremely large number of reader/sensor endpoints and to simultaneously receive on eight different receive channels. In a typical deployment, all sensor/readers on a farm may communicate with only a single gateway 160, thus reducing the overall system cost. This is made possible due to the relatively longer RF range (as compared to WiFi, Bluetooth and other near-field communication solutions) available using the selected sensor/readers and gateway 160.

Additional benefits are derived from the LoRa protocol and Symphony Link as well as the overall architecture of the present invention such that, as opposed to existing systems, only a single gateway 160 is required. Various techniques including adaptive data transmission rates are used in connection with the LoRa protocol to support the longer range transmissions required as well as the association of a large number of sensor/reader pairs with only a single gateway 160.

Gateway 160 may include processing components such as those described above to enable the processing of raw data sourced from the sensor/reader pairs into processed data that may be desired/required by users. In addition, gateway 160 preferably includes local storage for storing some or all of the raw and/or processed data locally. By storing this data locally in either or both of gateway 160 and/or at the readers, a network outage will not degrade or eliminate the capability to capture and communicate sensed data to users.

One important aspect of system 100, in a preferred embodiment thereof, is the ability for authorized users to manage and update gateway 160, radio modules (such as those associated with sensors and readers) and various controllers and microprocessors associated with sensors and nodes in the system. This may be accomplished using an application present on a user device 200 which communicates the desired changes and/or configuration information or commands to the applicable network components via cloud 180. Some or all of the components of system 100 can be updated seamlessly automatically over the air via cloud 180 as directed through user devices 200 and/or alternative system control elements. Updates may comprise, software improvements, new functionality, bug fixes, and configuration control, for example.

By way of example only, some or all of the following can be controlled remotely with system 100 as deployed in a farming application:
Configuration/RF parameters for local network connection(s) 170
Updating software/firmware in any/all of gateway 160, sensors, readers, repeaters, other connected user devices and other nodes
Configuring triggers for when alarms are generated by sensor/reader pairs on a location by location basis such as specific rates of grain depletion at each grain bin as a trigger for an alarm or triggers for drought warnings at each weather station based upon a specific low level of rain over some specified time period
Making gateway 160 aware of the addition of new sensor/reader pairs installed within the system and/or the relocation of such sensor/reader pairs to other grain bins or to different locations within the same grain bins

As will be readily apparent to one of skill in the art, the above is a listing of just a very few of the practically unlimited possibilities for changing, configuring, controlling and/or otherwise operating system 100 and the components thereof as desired by users of system 100. Many benefits are achieved through the use of the disclosed network and related architecture in light of the fact that all of these changes, configurations and controls can be done remotely from the nodes and system elements. In addition, it is beneficial that changes may be made globally with respect to a subset or all of the components/nodes within system 100 (rather than having to make the same change/command on a node by node basis). Again, these benefits are achieved as a result of the novel network and related architecture of system 100 as disclosed herein.

Gateway 160 communicates through a local network connection 170 (such as a Wifi network, cellular WAN or wired LAN) to cloud 180 (essentially, in this case, a remote private or public network). In a preferred embodiment cloud 180 provides an essentially unlimited capability for storing present as well as historical captured data from one or more farms. Various applications for processing raw and/or previously processed data may be enabled by cloud 180. For example, more data intensive applications as well as applications which require access to remote third party data and/or functionality may reside in the cloud as opposed to at the local system level as previously discussed. Examples may include applications that compare grain bin temperatures and humidity levels and ambient temperatures and humidity levels to historical temperatures and humidity levels for comparison and decision making purposes.

User Devices 200 may consist of tablets, desktop and laptop computers, smart phones, special purpose devices as well as any other device that includes a display and some means for user input. User devices 200 receive processed and in some cases raw data originally detected by sensor/reader pairs and which may have been processed locally or via cloud 180. Various applications may be resident on user devices 200 for displaying, formatting, configuring and otherwise presenting data as well as interacting with system 100 to request data, provide configuration details for data detection and/or set other system parameters. Some user devices (e.g. User Device #N in FIG. 1) may also interact with system 100 via a wireless connection (such as Wifi) directly to gateway 160 in addition to via cloud 180. As mentioned above, this provides reporting and control capabilities to users even if any of the connections (e.g. gateway 160 to cloud 180 or cloud 180 to user devices 200) fails.

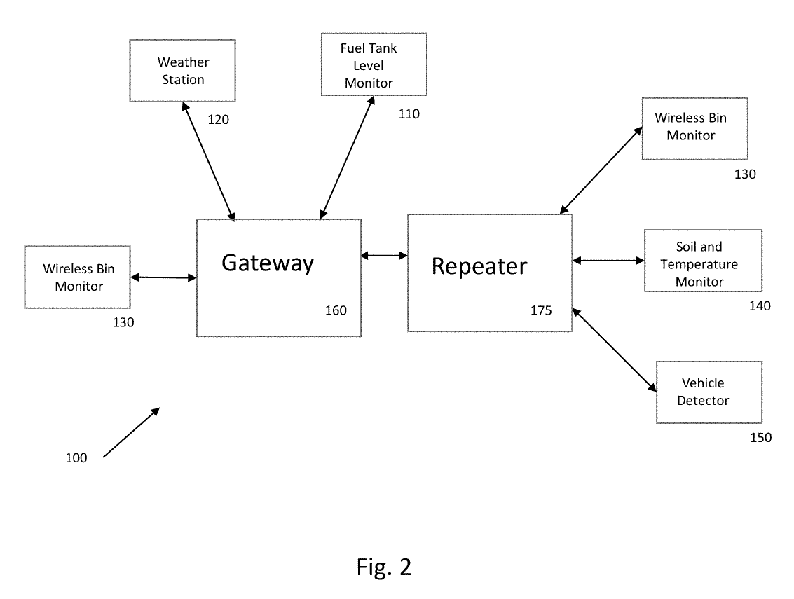

FIG. 2 illustrates another embodiment of system of the present invention wherein at least one repeater 175 is employed to provide extended communications ranges as needed. In the case of a large farm where the geographical distances between sensors/readers 120, 130, 140 and 150 on the one hand and gateway 160 on the other hand are large, one or more repeaters 175 may be included within the system to enhance connectivity and increase range such that a complete farm may still be covered with a single gateway 160 notwithstanding the large land area to be covered.

As shown in FIG. 2, repeater 175 may serve as an intermediate hopping element so as to connect some of the sensor/readers (in the case of FIG. 2, wireless bin monitor 140, soil moisture and temperature monitor 140 and vehicle detector 150) with gateway 160 which may be a large distance away from these sensor/reader pairs. Exemplary repeaters that may be employed in connection with the system of the present invention include, for example, those offered by Link-Labs as well as other devices that are LoRa/Symphony capable. Depending upon the conditions for RF transmissions (e.g. distances, topology etc.), repeater(s) 175 may be strategically located so as to provide extended range for one or more sets of sensor/reader pairs wherein each repeater 175 is located geographically between such sensor/reader pairs and gateway 160.

In the system 100 of the present invention, other sensor/reader pairs may wirelessly connect directly to gateway 160 depending on the conditions for RF transmissions (e.g. distances, topology, etc.) such that no repeater 175 is necessary for the link. System 100 may also be configured such that some or all of the sensor/reader pairs may selectively/alternatively communicate with gateway 160 either through repeater 175 or directly to gateway 160 without using repeater 175. Whether or not repeater 175 is in the path at any one time may be determined by various factors such as sensor-gateway distance of separation, physical obstacles between sensors and gateway, geographical topology, network congestion, weather factors, radio interference in the relevant area as well as other factors.

It will be noted that system 100 of the present invention is preferably architected according to a star network topology to achieve specific advantages. In such a case, gateway 160 may serve as the central switch/hub through which all other nodes (repeaters and/or sensor/reader pairs). By implementing this topology, line failure at a single connection point leaves all other connections intact thus minimizing network impact. Additionally, if required or desired, this topology allows sensor/reader pairs and/or repeaters to communicate with all other nodes in the network via gateway 160.

In an alternative embodiment, a mesh network topology or some derivation thereof may be employed for some or all portions of system 100. In this case, some or all of the repeaters and/or sensor/reader pairs may serve as an intermediate communication point between other repeaters and/or sensor/reader pairs and gateway 160 as well as other repeaters and/or sensor/reader pairs. As is known in the art, node to node paths must be determined and various self-healing techniques must be used to minimize loss of connectivity between any nodes and/or the gateway during operation of system 100.

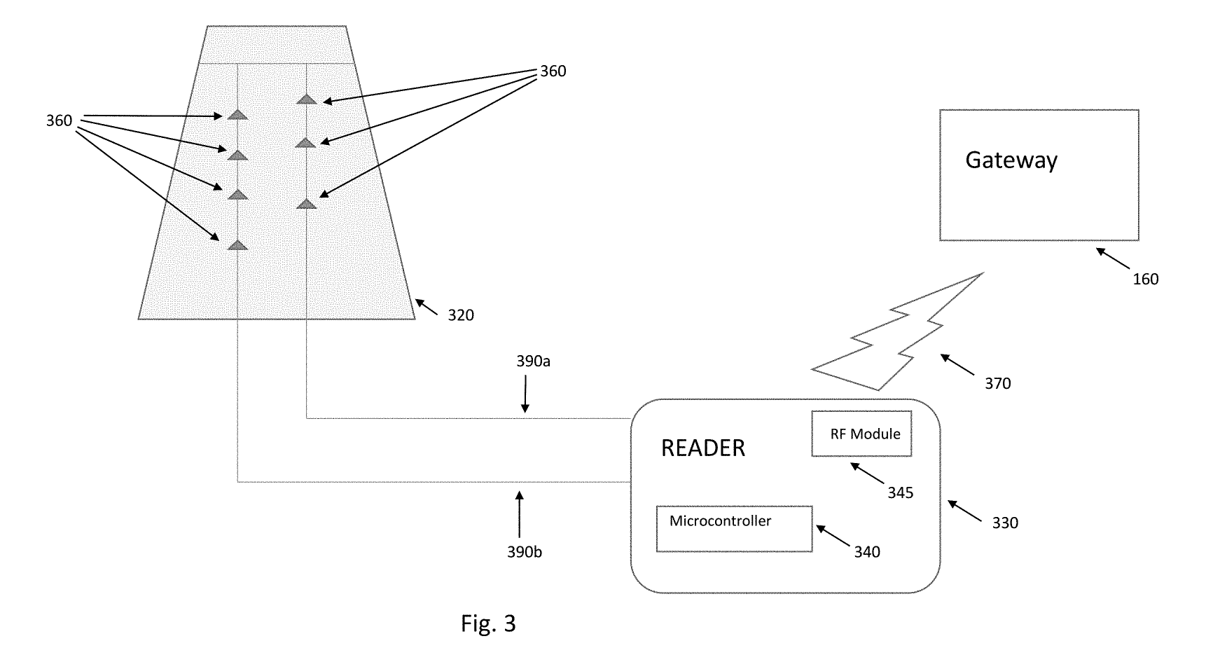

Turning now to FIG. 3, the specific components associated with sensing parameters at grain bin 320 are shown and now discussed. According to one embodiment of the present invention, a number of sensing cables 390a and 390b are deployed within grain bin 320. Cables 390a and 390a typically include a number of sensors 360 along the length of the cables to sense parameters within grain bin 320. Sensors 360 may be equidistant from one another along the cable or, alternatively, they may be spaced according to some other desired spacing scheme.

In one embodiment, cables 390a and 390b may comprise, for example, temperature sensing cables manufactured by Advanced Grain Management (OPI temperature and moisture cables) and available via the following internet website: www.advncedgrainmanagement.com/products/temperature-cables and www.advancedgrainmanagement.com/products/moisture-cables. These cables may alternatively or additionally be selected to detect and/or measure other parameters within grain bin 320. Examples include humidity and moisture level sensing, ambient temperature sensing, embedded grain temperature sensing etc.

In one embodiment, reader 330 may include one or more microcontrollers 340 (only one is shown) that read and process the raw sensory data and further communicate all or a portion of the raw and/or processed data to the gateway 160 via RF module 345. The reader 330 may receive settings such as RF settings and/or sensor reading frequencies from gateway 160. In one embodiment of the present invention, reader 330 may comprise components which include Symphony Link and/or LoRaWAN RF transceiver modules (Models LL-RLP-20/LL-RXR-27) made available by Link-Labs. These modules are optimized for use in connection with low power wide-area networks such as system 100 of the present invention.

In some embodiments, each reader 330 may be connected to six or more cables with cables 390a and 390b representing merely a portion of connected cables. All cables feeding to a reader may all be designed to sense the same type of parameters (e.g. all temperature sensing cables) or, alternatively, cables with heterogeneous sensing capabilities may all feed to reader 330. Reader 330 may engage controllers 340 to control operational characteristics such as frequency of sensing, sensing characteristics, and to perform operational performance checks from time to time.

As discussed above, reader 330 communicates with gateway 160 through a wireless connection preferably using the LoRa/Symphony protocols so as to provide relatively long transmission distances and to support a very large number of nodes with a single gateway (or, at least, a small number of gateways). The Symphony Link solution is designed to achieve carrier-grade connectivity with ranges that are 20 or more times the ranges typically provided by WiFi links—up to 7 miles. As noted above, repeaters may be deployed within system 100 to increase attainable ranges for larger farms or for multi-farm deployments.

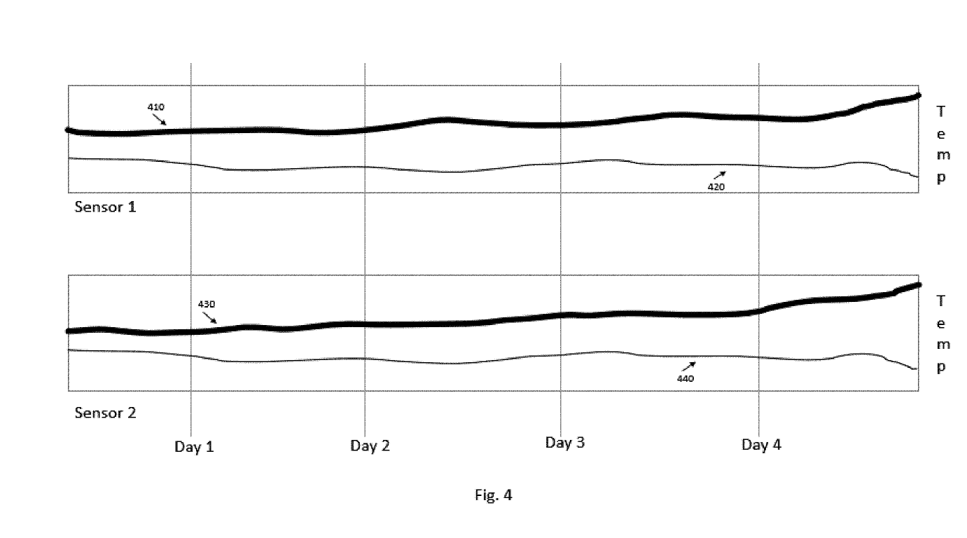

Turning now to FIG. 4, a graphical plot illustrating a heating condition within a grain bin as detected by the system of the present invention, according to an embodiment thereof, is provided. While the Figure only shows two sensors, in preferred embodiments of the present invention, a larger number of sensors will be disbursed at differing locations within the grain bin, preferably at differing heights within the bin and also possibly at different distances from the center axis running from the top of the bin through to the bottom of the bin. This may be accomplished, for example, by deploying sensors along more than one cable within the bin, as shown, for example in FIG. 3. In a preferred embodiment, three temperature cables (or more) are included within each bin.

In FIG. 4, lines 410 and 430 represent grain temperature as detected by sensors #1 and #2 respectively. In one embodiment, temperatures are read by sensors every five minutes. However, more or less frequent readings may be taken while remaining within the scope and spirit of the present invention.

Lines 420 and 440 represent ambient temperature which may detected by a temperature sensor outside of the bin, within an interior location housing a bin and/or outdoors near a bin. One or more than one ambient temperature sensors may be employed. In the example of FIG. 4, ambient temperature is the same across both sensor boxes, thus implying that lines 420 and line 440 represent ambient temperature over time as detected by a single sensor.

Although slightly different, both of lines 410 and 430 indicate a trending higher temperature for the grain at differing locations within the bin. This is in the context of a somewhat stable and possibly decreasing ambient temperature as represented by lines 420 and 440. The system of the present invention may report a potential issue at this grain bin representing a possible heating condition in the bin. This is confirmed by each of two sensors reporting a trending higher grain temperature at two different physical locations within the grain in the bin even in the context of a stable ambient temperature. This trending higher grain temperature may be indicative of grain heating which could be caused by germination or other biological activities within the grain which can be detrimental to all of the grain in the bin causing potential spoilage. Given such a warning, the farmer may be prompted to take remedial action with respect to this bin including possibly activating one or more aeration fans in an effort to lower the temperature of the grain. Prompting/notification may occur via reporting to gateway 160 (FIG. 1) which can then, in turn, transmit the notification to one or more user devices 200 (FIG. 1) either through cloud 180 or via a direct wireless connection (e.g. WiFi) between gateway 160 and user device 200, or both.

System 100 of the present invention may be configured to analyze for such heating conditions according to many different protocols. For example, in a case where a reasonably large number of sensors are present within a grain bin (e.g. 10-15 on a cable with 2 cables within the bin=20-30 overall sensors), analysis conducted by an application located within reader 330 and/or controller 340 may be used to determine whether a heating condition should be reported. For example, the trigger for such a warning may require a minimum slope of the temperature curve over a minimum period of time so as to eliminate false alarms.

According to the teachings of the present invention, various advantages are derived in connection with the detection and reporting of a heating condition within a grain bin through the use of the novel system architecture as described above. These include the ability to employ a large number of sensors and a single gateway at lower cost while providing high accuracy given the ability to deploy a large number of sensors at many locations within each bin and across a farm without running into problems such as battery depletion, RF range limitations, data communication errors/congestion and the like.

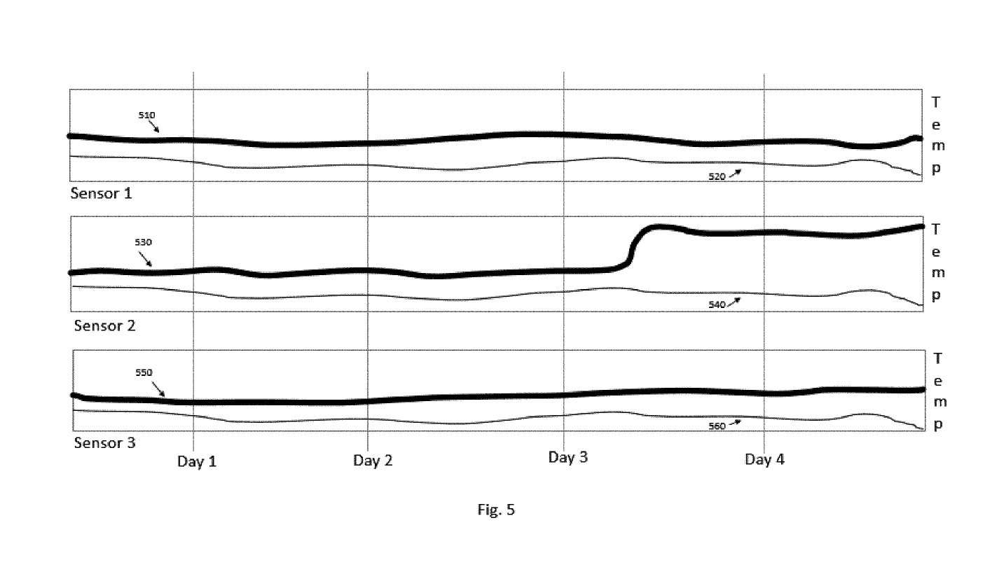

Turning now to FIG. 5, a graphical plot illustrating a “hot spot” condition within a grain bin as detected by the system of the present invention, according to an embodiment thereof, is provided. Hot spots can be caused by mold, germination, insects, plant cell activity or other biological activities for example. While the Figure only shows three sensors, in preferred embodiments of the present invention, a larger number of sensors will be disbursed at differing locations within the grain bin, preferably at differing heights within the bin and also possibly at different distances from the center axis running from the top of the bin through to the bottom of the bin. This may be accomplished, for example, by deploying sensors along more than one cable within the bin, as shown, for example in FIG. 3. In a preferred embodiment, three temperature cables (or more) are included within each bin.

In FIG. 5, lines 510, 530 and 550 represent grain temperature as detected by sensors #1, #2 and #3 respectively. In one embodiment, temperatures are read by sensors every five minutes. However, more or less frequent readings may be taken while remaining within the scope and spirit of the present invention.

Lines 520, 540 and 560 represent ambient temperature which may detected by a temperature sensor outside of the bin, within an interior location housing a bin and/or outdoors near a bin. One or more than one ambient temperature sensors may be employed. In the example of FIG. 5, ambient temperature is the same across both sensor boxes, thus implying that lines 520, 540 and 560 represent ambient temperature over time as detected by a single sensor.

Although slightly different, both of lines 510 and 500 indicate a stable temperature for the grain at two differing locations within the bin. This is in the context of a somewhat stable and possibly decreasing ambient temperature as represented by lines 520, 540 and 560. However, sensor #2 (as represented by line 530) shows a fairly rapid increase in temperature at the sensor #2 location within the bin beginning on Day 3 and continuing through the end of Day 4. The system of the present invention may report a potential issue at this grain bin representing a possible hot spot condition in the bin at the location of sensor #2. This is confirmed by each of two sensors (sensors #1 and #3) reporting a stable grain temperature at two different physical locations within the bin even in the context of a stable ambient temperature. However, at the location of sensor #2, a rapid increase in temperature is detected. This localized higher grain temperature may be indicative of hot spot within the grain which can be detrimental to all of the grain in the bin causing potential spoilage. Given such a warning, the farmer may be prompted to take remedial action with respect to this bin including possibly activating one or more aeration fans in an effort to lower the temperature of the grain and/or other actions designed to remediate the hot spot within the grain in the bin. Prompting/notification may occur via reporting to gateway 160 (FIG. 1) which can then, in turn, transmit the notification to one or more user devices 200 (FIG. 1) either through cloud 180 or via a direct wireless connection (e.g. WiFi) between gateway 160 and user device 200, or both.

System 100 of the present invention may be configured to analyze for such hot spot conditions according to many different protocols. For example, in a case where a reasonably large number of sensors are present within a grain bin (e.g. 10-15 on a cable with 2 cables within the bin=20-30 overall sensors), analysis conducted by an application located within reader 330 and/or controller 340 may be used to determine whether a hot spot condition should be reported. For example, the trigger for such a warning may require a minimum temperature and/or slope necessary to trigger the hot spot warning. Various models can be used to determine, for example, a minimum slope of the sensor curve and/or a minimum trigger temperature to warrant a hot spot warning.

According to the teachings of the present invention, various advantages are derived in connection with the detection and reporting of a hot spot condition within a grain bin through the use of the novel system architecture as described above. These include the ability to employ a large number of sensors and a single gateway at lower cost while providing high accuracy given the ability to deploy a large number of sensors at many locations within each bin and across a farm without running into problems such as battery depletion, RF range limitations, data communication errors/congestion and the like.

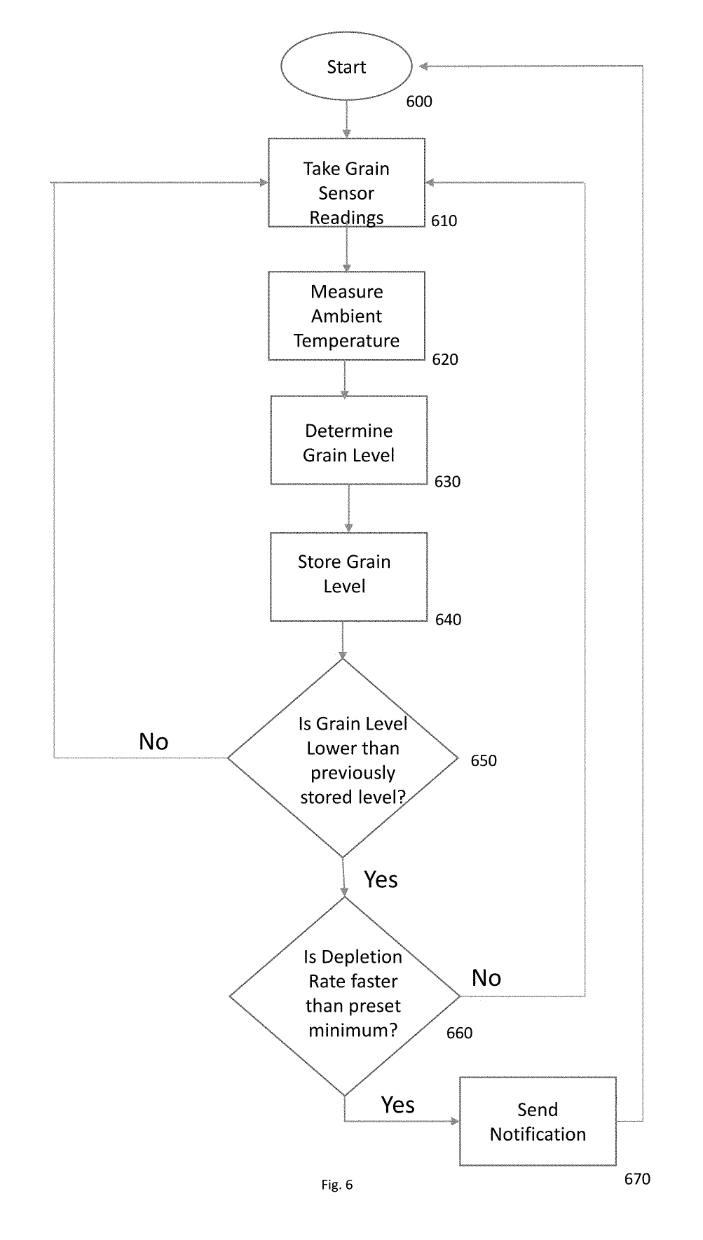

With reference now to FIG. 6, a flowchart illustrating the methodology for detecting a possible grain theft/rapid grain depletion condition within a grain bin, according to an embodiment thereof, is provided. In one embodiment of the present invention this process next described may be carried out by software and/or firmware resident in any or all of reader 330, controller 340, gateway 180 and/or cloud 180. The process begins at step 600. Control then proceeds to step 610 where grain sensor readings are taken. The frequency of the readings may be variable, random or at some pre-determined period. This parameter may be set, in one embodiment, by a user/farmer via user device 200. In one example, grain sensor readings, representing the temperature at various locations within the grain contained within a grain bin, are taken once every 5 minutes.

Following step 610, control passes to step 620 wherein one or more ambient temperature readings are taken by a different set of sensors. In some embodiments, step 610 and 620 may occur in parallel while in others either step may precede the other. By way of example, in step 620 ambient temperature readings, which represent temperature readings in the vicinity of but not within the grain, may be taken every 5 minutes. Again, less or more frequent readings may be taken without departing from the scope or spirit of the present invention.

At step 630, the grain level within a grain bin may be determined given the information obtained under steps 610 and 620. Since grain behaves as a thermal insulator, the readings from sensors that are in contact with the grain will be steady and generally uniform within the bin (unless there is a hot spot). The readings from the sensors not in contact with the grain (the ambient temperature sensors) will not be as steady as the in-grain sensors in terms of temperature fluctuation. As ambient temperature fluctuates, temperature readings from step 620 will deviate while temperature readings from step 610 will remain steadier.

Given the knowledge of sensor locations along the sensor cable, the height of each sensor within the grain bin is known. Along with known volumetric calculations, the grain level in the bin can thus be determined at step 630 based on an indication of which sensors fluctuate in temperature versus which sensors remain more steady in terms of temperature. Along these lines, the first sensor (in terms of height) along the sensor cable that shows ambient temperature variation represents the first level at which grain is not present (while it is assumed that at the next lower sensor which does not show the temperature variation, the grain is present), represents the height of the grain within the bin. In a circular bin, and with a known circumference, the estimated volume of grain can be determined.

In a preferred embodiment, various checks can be used to maximize the accuracy of the grain level determination under step 630. For example, if a first sensor which is located higher on the cable shows no temperature variation, while a second sensor below that first sensor does show temperature variation, an error condition may be reported since it is not generally possible for grain to be present at a higher level in the bin while not being present at a relatively lower level. Other checks may also be used to minimize errors in connection with grain level determination under step 630.

Once a grain level is determined at step 630, control then proceeds to step 640 where that level is stored in memory. More than one level in time may be stored for comparison purposes and to provide checks and balances in the determination. Next, at step 650, a determination is made as to whether the most recent grain level is lower than the previous reading. If the answer is yes, then processing continues to step 660. Alternatively, if the answer is no, control returns to step 610 (and 620) to take additional sensor readings on a periodic basis as discussed above.

In some embodiments, if step 660 is reached and it has thus been determined that the grain level is lower than it had been previously, the rate of depletion may then be assessed at step 660. This is performed in connection with the stored values obtained from step 640. One or more parameters can then be assessed at step 660 to determine whether a notification or rapid depletion (indicating possible theft) should be sent. For example, a minimum loss of volume of time can be set as the trigger (e.g. 1000-bushel reduction in less than one hour). If this depletion rate is exceeded, then a notification can be sent to one or more user devices 200 under step 670. Control may then return to start again at step 600. It will be understood by one of skill in the art that step 660 is optional and system 100 may be configured instead to report any depletion in a bin regardless of the rate.

According to the teachings of the present invention, various advantages are derived in connection with the detection and reporting of a rapid depletion in grain level within a grain bin through the use of the novel system architecture as described above. These include the ability to employ a large number of sensors and a single gateway at lower cost while providing high accuracy given the ability to deploy a large number of sensors at many locations within each bin and across a farm without running into problems such as battery depletion, RF range limitations, data communication errors/congestion and the like.

The present invention is not limited to the particular embodiments illustrated in the drawings and described above in detail. Those skilled in the art will recognize that other arrangements could be devised. The present invention encompasses every possible combination of the various features of each embodiment disclosed. One or more of the elements described herein with respect to various embodiments can be implemented in a more separated or integrated manner than explicitly described, or even removed or rendered as inoperable in certain cases, as is useful in accordance with a particular application While the present invention has been described with reference to specific illustrative embodiments, modifications and variations of the present invention may be constructed without departing from the spirit and scope of the present invention as set forth in the following claims.

While the present invention has been described in the context of methods of operating mobile parameter-sensing nodes connectable via wireless connections to a remote host, those skilled in the art will appreciate that the mechanism of the present invention is capable of being implemented and distributed in the form of a computer-usable medium (in a variety of forms) containing computer-executable instructions, and that the present invention applies equally regardless of the particular type of computer-usable medium which is used to carry out the distribution. An exemplary computer-usable medium is coupled to a computer such the computer can read information including the computer-executable instructions therefrom, and (optionally) write information thereto. Alternatively, the computer-usable medium may be integral to the computer. When the computer-executable instructions are loaded into and executed by the computer, the computer becomes an apparatus for practicing the invention. For example, when the computer-executable instructions are loaded into and executed by a general-purpose computer, the general-purpose computer becomes configured thereby into a special-purpose computer. Examples of suitable computer-usable media include: volatile memory such as random access memory (RAM); nonvolatile, hard-coded or programmable-type media such as read only memories (ROMs) or erasable, electrically programmable read only memories (EEPROMs); recordable-type and/or re-recordable media such as floppy disks, hard disk drives, compact discs (CDs), digital versatile discs (DVDs), etc.; and transmission-type media, e.g., digital and/or analog communications links such as those based on electrical-current conductors, light conductors and/or electromagnetic radiation.

Although the present invention has been described in detail, those skilled in the art will understand that various changes, substitutions, variations, enhancements, nuances, gradations, lesser forms, alterations, revisions, improvements and knock-offs of the invention disclosed herein may be made without departing from the spirit and scope of the invention in its broadest form.

What is claimed is:

1. A connected farming system comprising:
at least one environmental sensor disposed within a grain bin;
said at least one environmental sensor communicating with a reader, said reader comprising an RF module and at least one microcontroller configured to execute computer program instructions, wherein said at least one environmental sensor is configured to detect data regarding at least one environmental condition and wherein said RF module is configured to wirelessly communicate said data regarding said at least one environmental condition to a gateway device; and
at least one user device configured to receive said data regarding said at least one environmental condition from said gateway device through the cloud.

2. The connected farming system of claim 1 wherein said date regarding said at least one environmental condition is communicated from said gateway device to the cloud via a network connection.

3. The connected farming system of claim 1 wherein said wireless communication between said RF module and said gateway device is via a LoRa protocol.

4. The connected farming system of claim 1 wherein said wireless communication between said RF module and said gateway device is via a Symphony Link protocol.

5. The connected farming system of claim 1 wherein said at least one user device also communicates with said gateway via a direct local wireless connection.

6. The connected farming system of claim 5 wherein said local wireless connection comprises a WiFi connection.

7. The connected farming system of claim 1 wherein said at least one user device comprises a smartphone device.

8. The connected farming system of claim 1 wherein said at least one environmental sensor comprises a plurality of temperature sensors located along at least one cable dispersed within grain held within a grain bin.

9. The connected farming system of claim 8 wherein said at least one cable is connected to said reader through a wired connection.

10. The connected farming system of claim 1 further including at least one repeater providing intermediate connectivity between said reader and said gateway.

11. The connected farming system of claim 8 wherein said reader is configured to determine one or more hot spots within said grain held within said grain bin based on temperature data reported by said temperature sensors.

12. The connected farming system of claim 11 wherein said determination of said one or more hot spots is based on an indication of a minimum increase in temperature occurring with respect to at least one of said temperature sensors within a predetermined timeframe.

13. The connected farming system of claim 12 wherein said determination also includes consideration of any change in ambient temperature during said predetermined timeframe.

14. The connected farming system of claim 8 wherein said reader is configured to determine an incidence of grain depletion within said grain bin based on temperature data reported by said temperature sensors.

15. The connected farming system of claim 14 wherein said determination of said incidence of grain depletion is based on an indication of a minimum fluctuation in temperature occurring with respect to at least one of said temperature sensors within a predetermined timeframe.

16. The connected farming system of claim 15 wherein said determination also includes consideration of any change in ambient temperature during said predetermined timeframe.

17. A method for determining the presence of a hot spot within grain housed within a grain bin comprising the steps of:
providing at least temperature sensor disposed within a grain bin wherein said at least one temperature sensor communicates with a reader, said reader comprising an RF module and at least one microcontroller configured to execute computer program instructions, and wherein said at least one temperature sensor is configured to detect temperature data and wherein said RF module is configured to wirelessly communicate said temperature data to a gateway device,
said reader determining the presence of a hot spot based on said temperature data and based on an indication of a minimum increase in temperature occurring with respect to at least one of said temperature sensors within a predetermined timeframe; and
communicating the presence of said hot spot to at least one user device configured to receive said communication from said gateway device through the cloud.

18. The method of claim 17 wherein the step of said reader determining the presence of a hot spot further includes consideration of any change in ambient temperature during said predetermined timeframe.

19. A method for determining an indication of grain depletion within a grain bin comprising the steps of:
providing at least temperature sensor disposed within a grain bin wherein said at least one temperature sensor communicates with a reader, said reader comprising an RF module and at least one microcontroller configured to execute computer program instructions, and wherein said at least one temperature sensor is configured to detect temperature data and wherein said RF module is configured to wirelessly communicate said temperature data to a gateway device,
said reader determining an indication of grain depletion based on said temperature data and based on an indication of a minimum fluctuation in temperature occurring with respect to at least one of said temperature sensors within a predetermined timeframe; and
communicating the indication of grain depletion to at least one user device configured to receive said communication from said gateway device through the cloud.

20. The method of claim 19 wherein the step of said reader determining the indication of grain depletion further includes consideration of any change in ambient temperature during said predetermined timeframe.
